(19) United States
(12) Patent Application Publication
(10) Pub. No.: US 2026/0088376 A1
(43) Pub. Date: Mar. 26, 2026

(54) CHARGE AND DISCHARGE CONTROL METHOD FOR CHARGE AND DISCHARGE ELEMENT, AND CHARGE AND DISCHARGE CONTROL DEVICE FOR CHARGE AND DISCHARGE ELEMENT

(71) Applicant: NISSAN MOTOR CO., LTD., Yokohama-shi, Kanagawa (JP)

(72) Inventors: Yuki NISHIO, Kanagawa (JP); Kensuke MURAI, Kanagawa (JP); Kenta SUZUKI, Kanagawa (JP)

(73) Assignee: NISSAN MOTOR CO., LTD., Yokohama-shi, Kanagawa (JP)

(21) Appl. No.: 19/112,778

(22) PCT Filed: Sep. 19, 2022
(86) PCT No.: PCT/IB2022/000524

§ 371 Date: Mar. 18, 2025

(51) Int. Cl. H01M 10/44; B60L 58/18; H01M 10/42; H01M 10/48

(52) U.S. Cl. CPC H01M 10/441; B60L 58/18; H01M 10/425; H01M 10/482; B60L 2240/54; H01M 2010/4271; H01M 2010/4278

(57) ABSTRACT

A charge and discharge control method for a charge and discharge element is performed every control cycle from a start time. Electric energy consumption is measured by integrating electric power consumption of a group including one or more charge and discharge elements, as a whole, from the start time to a control time at which one or more control cycles have elapsed. Target electric energy is acquired by integrating target electric power predetermined for the group as a whole from the start time to the control time. A command value is determined based on an average electric energy, which is obtained by dividing an energy difference electric obtained by subtracting the electric energy consumption from the target electric energy. The one or more charge and discharge elements autonomously control their own charge and discharge electric power based on the command value.

### TECHNICAL FIELD

The present invention relates to a charge and discharge control method for a charge and discharge element, and a charge and discharge control device for a charge and discharge element.

### BACKGROUND ART

Patent Literature 1 describes an electric power control system for controlling total electric power consumption by a plurality of electric power consumption elements in a group. With this technology, a broadcast element transmits information of an indicated value to the electric power consumption elements in the group for every control cycle of the group total electric power consumption. The indicated value is a function of the difference between a current value and a reference value of total electric power consumption in the group. Each electric power consumption element determines a value of target electric power consumption corresponding to its own priority, based on the indicated value each time when receiving the indicated value. The electric power consumption elements that determine the target values control their own electric power consumption to the determined target value.

### CITATION LIST

### Patent Literature

PATENT LITERATURE 1: U.S. Pat. No. 6,168,528

### SUMMARY OF THE INVENTION

### Technical Problem

In the electric power control system in Patent Literature 1, each electric power consumption element determines a target value for a control cycle at this time, based on a target value determined for a control cycle at a previous time. When a new electric power consumption element is added to a group, other electric power consumption elements present in the group before the addition determine a target value at this time based on a target value at a previous time determined before the addition, and consumes electric power by the determined target value immediately after the addition of the new electric power consumption element. The new electric power consumption element added to the group does not determine a target value before the addition, and cannot determine a target value at this time based on a target value at a previous time, and consumes the electric power remaining after subtracting the consumption by other electric power consumption elements, immediately after the addition to the group.

In the electric power control system in Patent Literature 1, the electric power consumption by other electric power consumption elements present in the group before the addition takes priority immediately after the addition of the new electric power consumption element to the group. When the electric power remaining after subtracting the total electric power consumption by other electric power consumption elements from a reference value of total electric power consumption is small, the new electric power consumption element cannot consume electric power corresponding to its priority even if that priority is high.

The present invention has been made in view of the above circumstances, and an object of the present invention is to enable a new charge and discharge element, added to a group including a load and a charge and discharge element that consume electric power, to charge and discharge electric power according to its priority immediately after the addition to the group.

### Solution to Problem

In order to solve the problems described above, a charge and discharge control method for a charge and discharge element according to one aspect of the present invention provides a charge and discharge control method for a charge and discharge element, performed every control cycle from a start time. In this charge and discharge control method for a charge and discharge element, electric energy consumption is measured by integrating electric power consumption of a group including one or more charge and discharge elements, as a whole, from the start time to a control time at which one or more control cycles have elapsed. Target electric energy is acquired by integrating target electric power predetermined for the group as a whole from the start time to the control time; and a command value is determined based on an average electric energy, which is obtained by dividing an electric energy difference obtained by subtracting the electric energy consumption from the target electric energy, over the control cycle. The determined command value is broadcast to the one or more charge and discharge elements. The one or more charge and discharge elements that receive the command value autonomously control their own charge and discharge electric power, based on the command value.

### Advantageous Effects of Invention

According to the present invention, a new charge and discharging element added to a group including a load, and a charge and discharging element that consumes electric power, can be charged and discharged according to its priority immediately after addition to the group.

### BRIEF DESCRIPTION OF DRAWINGS

FIG. 1 illustrates a configuration of an electric power system for supplying electric power to an electric power consumption element including an electric vehicle, to which a charge and discharging control method according to a first embodiment of the present invention is applied.

FIG. 2 is a graph illustrating a transition of total electric power consumption of a group as a whole for each control cycle of a charge and discharge control method to be compared when the charge and discharge control method is applied to the charge and discharge control of an electric vehicle added to a group in which only an electric load is present.

FIG. 3 is a flowchart illustrating an example of processing performed by units of a command device in FIG. 1 at each control time during a predetermined time interval.

FIG. 4A is a graph illustrating a case in which a difference between total electric energy consumption and a total electric power consumption target value in the group determined at a control time by a command value calculation unit in FIG. 1 changes in a range of values greater than or equal to 0, in the charge and discharge control method according to the first embodiment of the present invention.

FIG. 4B is a graph illustrating a case in which a difference between the total electric power consumption and the total electric energy consumption target value in the group determined at a control time by a command value calculation unit in FIG. 1 changes in a range of values greater than or equal to 0, in the charge and discharge control method according to the first embodiment of the present invention.

FIG. 4C is a graph illustrating a case in which a difference between the total electric energy consumption and the total electric power consumption target value in the group determined at a control time by a command value calculation unit in FIG. 1 changes in a range of values greater than or equal to 0, in the charge and discharge control method according to the first embodiment of the present invention.

FIG. 4D is a graph illustrating a case in which a difference between the total electric energy consumption and the total electric power consumption target value in the group determined at a control time by a command value calculation unit in FIG. 1 changes in a range of values less than 0, in the charge and discharge control method according to the first embodiment of the present invention.

FIG. 4E is a graph illustrating a case in which a difference between the total electric energy consumption and the total electric power consumption target value in the group determined at a control time by a command value calculation unit in FIG. 1 changes in a range of values less than 0, in the charge and discharge control method according to the first embodiment of the present invention.

FIG. 4F is a graph illustrating a case in which a difference between the total electric energy consumption and the total electric power consumption target value in the group determined at a control time by a command value calculation unit in FIG. 1 changes in a range of values less than 0, in the charge and discharge control method according to the first embodiment of the present invention.

FIG. 5 is a flowchart illustrating an example of processing performed by units of the charge and discharge control device in FIG. 1 when arriving at a control time in each control cycle.

FIG. 6 is a graph illustrating a transition of the total electric power consumption of a group, as a whole, for each control cycle of the charge and discharge control when the charge and discharge control method according to the first embodiment of the present invention is applied to the charge and discharge control of the electric vehicle added to the group in which only the electric load of FIG. 1 is present.

FIG. 7 is a graph illustrating a state of total electric power consumption of a group, as a whole, that occurs during a period from a start time of a predetermined time interval to a subsequent control time in the charge and discharge control method according to the first embodiment of the present invention and a modification thereof.

FIG. 8 is a flowchart illustrating an example of processing performed by units of the command device illustrated in FIG. 1 at each control time during a predetermined time interval in the charge and discharge control method according to the second embodiment of the present invention.

FIG. 9A is a graph illustrating a case in which a difference between the total electric energy consumption and the total electric power consumption target value in the group, determined at a control time by a command value calculation unit in FIG. 1, changes in a range of values greater than or equal to 0, in the charge and discharge control method according to a second embodiment of the present invention.

FIG. 9B is a graph illustrating a case in which a difference between the total electric energy consumption and the total electric power consumption target value in the group, determined at a control time by a command value calculation unit in FIG. 1, changes in a range of values greater than or equal to 0, in the charge and discharge control method according to the second embodiment of the present invention.

FIG. 9C is a graph illustrating a case in which a difference between the total electric energy consumption and the total electric power consumption target value in the group, determined at a control time by a command value calculation unit in FIG. 1, changes in a range of values greater than or equal to 0, in the charge and discharge control method according to the second embodiment of the present invention.

FIG. 9D is a graph illustrating a case in which a difference between the total electric energy consumption and the total electric power consumption target value in the group, determined at a control time by a command value calculation unit in FIG. 1, changes in a range of values less than 0, in the charge and discharge control method according to a second embodiment of the present invention.

FIG. 9E is a graph illustrating a case in which a difference between the total electric energy consumption and the total electric power consumption target value in the group, determined at a control time by a command value calculation unit in FIG. 1, changes in a range of values less than 0, in the charge and discharge control method according to a second embodiment of the present invention.

FIG. 9F is a graph illustrating a case in which a difference between the total electric power consumption and the total electric power consumption target value in the group, determined at a control time by a command value calculation unit in FIG. 1, changes in a range of values less than 0, in the charge and discharge control method according to a second embodiment of the present invention.

### DESCRIPTION OF EMBODIMENTS

### First Embodiment

Hereinafter, an embodiment and a modification thereof according to the present invention will be described with reference to the drawings. In the drawings, the same parts are denoted by the same reference numerals, and the description thereof will be omitted.

### (Electric Power System)

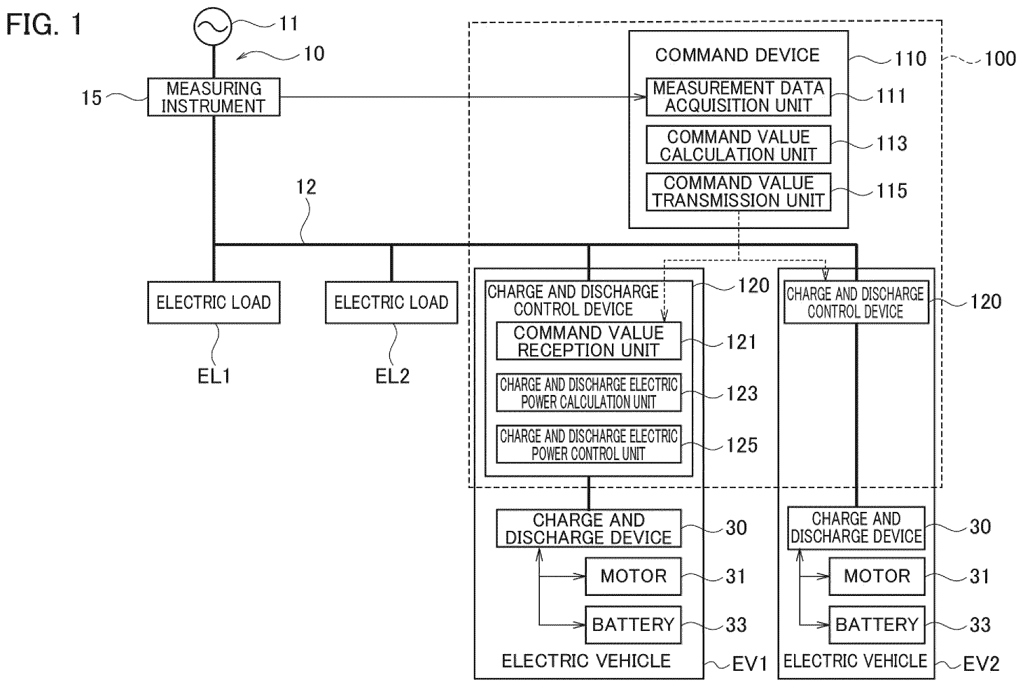

Referring to FIG. 1, a configuration of an electric power system which supplies electric power to an electric power consuming element including an electric vehicle, to which a charge and discharge control method according to a first embodiment of the present invention is applied, will be described. An electric power system 10 illustrated in FIG. 1 is an electric power system capable of controlling and optimizing the flow of electric power from both a supply-side and a demand-side. The electric power system 10 may include a smart grid, a smart community, a micro grid, or a mansion energy management system (MEMS) that manages a terminal consumption part from an energy supply source through a communication network in a limited area such as a business office or factory.

The electric power system 10 includes an electric power grid 11, an electric wire 12, a measuring instrument 15, and a command device 110.

The electric power grid 11 includes various power stations, such as a thermal, nuclear, or hydroelectric power station, as well as substations for transforming a voltage of several hundred thousand volts (V) to several thousand volts (V).

The electric wire 12 is connected to the electric power grid 11 via the measuring instrument 15 and a transformer (not illustrated). The transformer (not illustrated) is, for example, a pole transformer that changes a voltage applied to a high-voltage distribution line to a voltage used in a home or office. An electric power consumption element is connected to the electric wire 12.

The electric power consumption element includes one or more electric loads that only consume supplied power, and one or more charge and discharge elements that perform charging and discharging. The charge and discharge elements can receive electric power from the electric wire 12, or transmit electric power to the electric wire 12. In the following description, all the electric power consumption elements connected to the electric wire 12 of one electric power system 10 may be collectively referred to as a group. The electric wire 12 supplies electric power transformed by a transformer (not illustrated) to the electric power consumption elements in the group.

FIG. 1 illustrates a case in which two electric loads EL1 and EL2, and two electric vehicles EV1 and EV2 are connected to the electric wire 12. The number of electric loads and the number of electric vehicles connected to the electric wire 12 may be one, or three or more. The number of electric loads and the number of electric vehicles connected to the electric wire 12 may be the same or different.

In an embodiment, “electric vehicles EV1 and EV2” are given as an example of a “charge and discharge element” that charges and discharges electric power through the electric wire 12. A charge and discharge element stores received electric power in a battery (including a secondary battery, storage battery, or rechargeable battery). The “charge and discharge element” includes any equipment or device that has a battery, such as vehicles (including an electric vehicle, a hybrid vehicle, a construction machine, or an agricultural machine), railway vehicles, playground equipment, tools, household products, and other household items. In an embodiment, an example of a charge and discharge element is an electric vehicle (EV) that uses electricity as an energy source, and uses a motor as a power source. However, it is not intended that the charge and discharge element in the present invention be limited to an electric vehicle (EV).

The “charge and discharge element” indicates a unit configuration of charge and discharge control according to the charge and discharge control method according to the embodiment. In other words, charge and discharge control according to the embodiment is performed using the charge and discharge element as a unit. For example, charge and discharge control is performed independently, and in parallel for each of a plurality of the electric vehicles EV1 and EV2.

The measuring instrument 15 measures a current flowing through the electric wire 12, and calculates integrated electric energy consumption by the electric loads EL1 and EL2 and electric vehicles EV1 and EV2 connected to the electric wire 12, based on a measured current and a voltage of the electric wire 12. For example, smart meters with communication functions are installed at contracted parties of the electric power supply, and the measuring instrument 15 can calculate integrated electric energy consumption by collecting and aggregating integrated electric energy consumption of contracted parties measured by the smart meters.

The command device 110 constitutes a charge and discharge electric power control system 100 together with a charge and discharge control device 120 of the electric vehicles EV1 and EV2 described below. The charge and discharge control device 120 is installed in each of the electric vehicles EV1 and EV2.

The command device 110 and the charge and discharge control device 120 each have a general-purpose microcontroller (not illustrated). The microcontroller includes a CPU (Central Processing Unit) and a memory (not illustrated). The memory includes ROM (Read Only Memory) and RAM (Random Access Memory).

The microcontroller can virtually construct a plurality of information processing circuits by executing a program stored in the memory by the CPU. The plurality of information processing circuits can be used to configure units 111 to 115 of the command device 110, and units 121 to 125 of the charge and discharge control device 120 described below.

The present embodiment illustrates an example of realizing a plurality of information processing circuits constructed in the microcontroller by software. Of course, it is also possible to configure the information processing circuits by preparing dedicated hardware for executing steps of the information processing described below. Alternatively, a plurality of information processing circuits may be constructed by individual hardware. The dedicated hardware includes devices such as application-specific integrated circuits (ASIC) prepared to execute functions of the units 111 to 115, and 121 to 125 described below, and conventional circuit components.

The microcontroller of the command device 110 can configure a measurement data acquisition unit 111, a command value calculation unit 113, and a command value transmission unit 115 by a plurality of information processing circuits that are virtually constructed.

The command device 110 performs control so that an actual total electric energy consumption by the electric loads EL1 and EL2 and the electric vehicles EV1 and EV2 is below a target value of total electric energy consumption in the electric power system 10.

Here, another charge and discharge control method different from the present embodiment will be described for comparison. A charge and discharge control method will be described when the control performed in the electric power control system of Patent Literature 1 described in background art is applied to the charge and discharge control of an electric vehicle added to a group in which only an electric load is present.

In the electric power control system in Patent Literature 1, a broadcast element transmits information on an indicated value to each electric power consumption element in a group at a control time coming in each control cycle. The indicated value is a value obtained by multiplying the difference between a current value of the total electric power consumption in a group and a reference value by a system sensitivity. The system sensitivity is a parameter that defines responsiveness of each electric power consumption element to the indicated value.

Taking ΔP(t) as the difference obtained by subtracting the current value of the total electric power consumption in the group at a control time t from the reference value, and taking the system sensitivity of each electric power consumption element to an indicated value as gain, the indicated value is ΔP(t)×gain. The difference ΔP(t) is an instantaneous value at the control time t, and the unit of the difference ΔP(t) is watts (W).

Each electric power consumption element receives an indicated value at each control cycle, and determines a target value of electric power consumption corresponding to its priority, based on the indicated value received. Each electric power consumption element determines a target value of a control cycle at this time, based on a target value of a control cycle at a previous time, at a control time arriving in each control cycle.

When a control cycle is ts, and the priority of each electric power consumption element at the control time t is β(t), a target value P(t) of each electric power consumption element at the control time t is obtained by formula (1).

$$P ( t ) = P ( t - t s ) + β ( t ) \times Δ P ( t ) \times gain \qquad formula ( 1 )$$

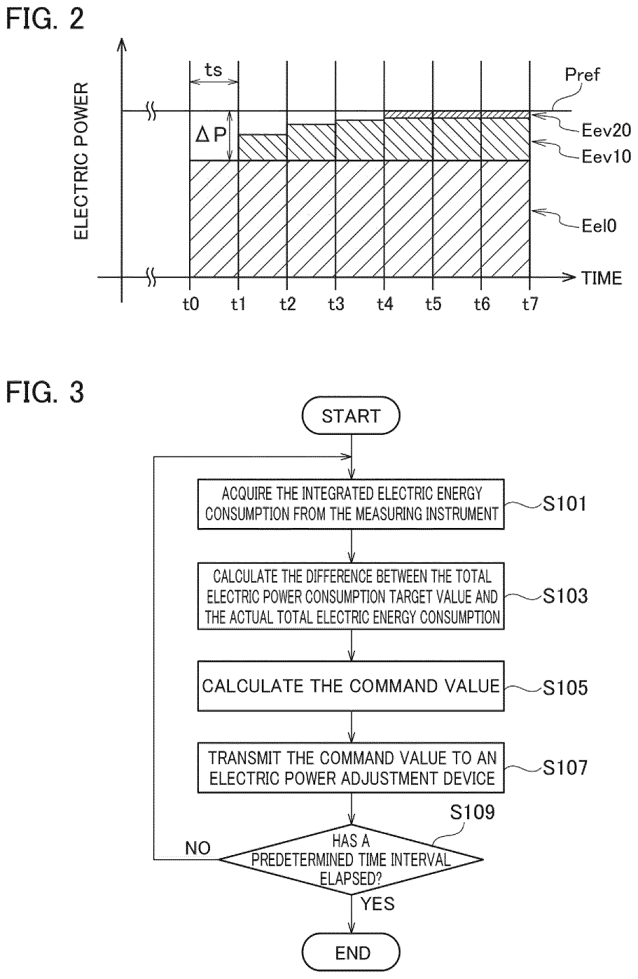

When control performed for an electric power consumption element in the electric power control system of Patent Literature 1 is applied to the control of an electric vehicle in a group in which electric loads and electric vehicles are mixed, for example, a transition of total electric power consumption occurs in the group, as illustrated in the graph of FIG. 2. A transition of total electric power consumption of the group as a whole when two electric vehicles are added to a group in which only electric loads are present at a control time t0 is illustrated in FIG. 2.

In the example in FIG. 2, the charge and discharge of a first electric vehicle added to the group first starts at a control time t1, and the charge and discharge of a second electric vehicle added to the group next starts at a control time t4.

At the control time t1, charging and discharging of the first electric vehicle added to the group starts. Based on an indicated value received at the control time t1, the first electric vehicle determines a target value P (t1) by formula (1), and starts charging and discharging with the target value P (t1) at the control time t1.

The first electric vehicle does not determine a target value P (t0) at a control time t0 before being added to the group. The target value P (t1) at the control time t1 obtained by the first electric vehicle by formula (1) is a value corresponding to the indicated value received at the control time t1 with the target value P (t0) at the control time t0, which is a target value at a previous time, being set to 0 in formula (1).

The indicated value received at the control time t1 by the first electric vehicle includes a difference ΔP (t0) obtained by subtracting the current value of the total electric power consumption in the group from a reference value Pref at the control time t0 before the first electric vehicle starts charging and discharging.

The difference ΔP (t0) at the control time t0 is only electric power consumption Eel0 due to the electric load present in the group at the control time t0. The electric power consumption Eel0 is less than the reference value Pref of the total electric power consumption in the group by ΔP. The difference ΔP (t0) at the control time t0 is a value greater than or equal to 0, obtained by subtracting the electric power consumption Eel0 from the reference value Pref.

The target value P (t1) at the control time t1 obtained by the first electric vehicle, based on an indicated value at the control time t1 including the difference ΔP (t0) greater than or equal to 0, is a value greater than the electric power consumption Eel0 of the electric load at the control time t0, which is the current value of the total electric power consumption in the group at the control time t0. The first electric vehicle starts charging at the control time t1 with the target value P (t1) greater than the current value of the total electric power consumption in the group.

The first electric vehicle receives a new indicated value at a control time t2, and determines a target value P (t2) based on the new indicated value by formula (1). A part of formula (1) excluding the target value P (t1) at the control time t1, which is a previous target value, includes an indicated value received by a first electric vehicle at the control time t2. The indicated value received at the control time t2 includes a difference ΔP (t1) obtained by subtracting the current value of the total electric power consumption in the group at the control time t1 at the previous time, from the reference value Pref.

At the previous control time t1, the first electric vehicle starts charging. The difference ΔP (t1) at the control time t1 is electric power obtained by summing up the electric power consumption Eel0 of the electric load present in the group at the control time t1, and the electric power consumption Eev10 due to charging of the first electric vehicle. In the following description, for ease of description, it is assumed that the electric power consumption Eev10 by the electric vehicle at the value of the control time t0 does not change even after the control time t1.

The electric power obtained by summing up the electric power consumption Eel0 and the electric power consumption Eev10 at the control time t1 becomes less than the reference value Pref when the first electric vehicle charges at the target value P (t1) determined at the control time t1. The difference ΔP (t1) at the control time t1 decreases by the electric power consumption Eev10 compared to the difference ΔP (t0) at the control time t0, but is still a value greater than or equal to 0.

The target value P (t2) at the control time t2 determined by the first electric vehicle by Formula (1) is obtained by adding a value corresponding to an indicated value at the control time t2, including the difference ΔP (t1) greater than or equal to 0, to the target value P (t1) at the control time t1. The first electric vehicle continues charging after the control time t2 with the target value P (t2) greater than the target value P (t1) at the control time t1.

The first electric vehicle receives a new indicated value at a control time t3, and a target value P (t3) is determined by Formula (1) based on the new indicated value in the same manner as at the control time t2. The indicated value received by the first electric vehicle at the control time t3 included in Formula (1) includes a difference ΔP (t2) at the control time t2.

The difference ΔP (t2) at the control time t2 is an electric power obtained by summing up the electric power consumption Eel0 of the electric load present in the group at the control time t2, and the electric power consumption Eev10 by the first electric vehicle.

The electric power obtained by summing up the electric power consumption Eel0 and the electric power consumption Eev10 at the control time t2 becomes less than the reference value Pref when the first electric vehicle charges at the target value P (t2) determined at the control time t2. The difference ΔP (t2) at the control time t2 decreases compared to the difference ΔP (t1) at the control time t1 due to an increase in the electric power consumption Eev10 caused by continued charging by the first electric vehicle after the control time t2, but is still a value greater than or equal to 0.

A target value P (t3) at the control time t3 determined by the first electric vehicle by Formula (1) is obtained by adding a value corresponding to an indicated value at the control time t3, including the difference ΔP (t2) greater than or equal to 0, to the target value P (t2) at the control time t2. The first electric vehicle continues charging after the control time t3 with the target value P (t3) greater than or equal to 0, which is greater than the target value P (t2) at the control time t2.

The first electric vehicle receives a new indicated value at a control time t4, and determines a target value P (t4) based on the new indicated value in the same manner as the target value P (t3) determined at the control time t3. The target value P (t4) at the control time t4 is greater than the target value P (t3) at the control time t3. The first electric vehicle continues charging after the control time t4 with the target value P (t4) greater than the target value P (t3) at the control time t3.

At the control time t4, charging and discharging of the second electric vehicle added to the group starts. Based on the indicated value received at the control time t4, the second electric vehicle determines a target value P (t4) by formula (1), and starts charging and discharging by the target value P (t4) at the control time t4.

The second electric vehicle does not determine the target value P (t3) at the control time t3 before being added to the group. The target value P (t4) at the control time t4 determined by the second electric vehicle by Formula (1) corresponds to the indicated value received at the control time t4, with the target value P (t3) at the control time t3 as a previous target value in formula (1) being set to 0.

The indicated value received by the second electric vehicle at the control time t4 includes a difference ΔP (t3) greater than or equal to 0. The target value P (t4) at the control time t4, determined by the second electric vehicle based on the indicated value at the control time t4, including the difference ΔP (t3) greater than or equal to 0, is greater than a current value of the total electric power consumption in the group at the control time t3. The current value of the total electric power consumption in the group at the control time t3 indicates an electric power obtained by summing up the electric power consumption Eel0 of the electric load at the control time t3, and the electric power consumption Eev10 of the first electric vehicle. With the target value P (t4) greater than the electric power obtained by summation, the second electric vehicle starts charging at the control time t4.

The difference ΔP (t3) included in the indicated value at the control time t4 decreases compared to the differences ΔP (t1) and ΔP (t2) included in the indicated values at the control times t2 and t3, due to an increase in the electric power consumption Eev10 caused by the charging of the first electric vehicle starting earlier than the second electric vehicle.

If the difference ΔP (t3) included in the indicated value at the control time t4 is insufficient for the electric power consumed by the second electric vehicle by the charging that starts at the control time t4, then the target value P (t4) at the control time t4 determined by the second electric vehicle is limited to a value less than or equal to a reference value Pref. In this case, it becomes difficult to secure electric energy required by the second electric vehicle for charging at the target value P (t4) determined by the second electric vehicle.

If the second electric vehicle has a priority higher than that of the first electric vehicle, the charging of the first electric vehicle that started charging earlier increases a total electric power consumption in the group, and as it approaches the reference value Pref, it becomes difficult to secure electric energy required by the second electric vehicle.

When an electric vehicle determines the target value P(t) at the control time t, charging and discharging of the electric vehicle with the target value P(t) continues until a next control time t+ts. As expressed in Formula (1), the target value P (t) includes a target value P (t−ts) at a previous control time t−ts, and an indicated value received at the control time t. These values are instantaneous values in watts.

The target value P(t) is limited to a value less than or equal to the reference value Pref. If the target value P (t) is less than the reference value Pref, the electric power (watts, W) of the difference between the reference value Pref and the target value P(t) is not consumed by charging and discharging of the electric vehicle. During a control cycle ts until the next control time t+ts when charging and discharging by the electric vehicle (t) continues with the target value P, an electric energy (watt hours, Wh) obtained by integrating the difference between the reference value Pref and the target value P (t) in the control cycle ts remains without being effectively consumed. In the graph of FIG. 2, the area of a portion with no hatch below the reference value Pref that is present between two consecutive control times is proportional to the electric energy remaining without being effectively consumed.

In the present embodiment, for every predetermined time interval, control is performed to keep the electric energy consumption of a group as a whole, which is integrated from a start time of a predetermined time interval, below a target electric energy. The target electric energy is a value obtained by integrating a target power predetermined for the group as a whole from the start time. The predetermined time interval is an interval longer than the control cycle ts of the control performed for every predetermined time interval.

When an electric power company providing the electric power system 10 in FIG. 1 calculates an electric power rate in a power purchase agreement based on electric capacitance per unit time, a predetermined time interval may be determined based on this unit time. When the electric power company determines the power rate, for example, based on the electric capacitance used during 30 minutes starting from every hour on the hour, and every hour on the half hour, the predetermined time interval may be 30 minute intervals with a start time being every hour on the hour, and every hour on the half hour in accordance with a measurement period of the electric capacitance.

The microcontroller of the command device 110 in FIG. 1 executes processing to keep the electric energy consumption of a group as a whole, integrated from a start time of a predetermined time interval, less than or equal to a target electric energy at two or more control times ts that arrive during a predetermined time interval. The control cycle ts may be, for example, 10 seconds. The processing can be performed by the microcontroller at each control time, for example, as illustrated in the flowchart of FIG. 3.

When the microcontroller starts the processing at a start time of a predetermined time interval, in step S101, the measurement data acquisition unit 111 acquires integrated electric energy consumption calculated by the measuring instrument 15 from the measuring instrument 15 as the integrated electric energy consumption at a current control time. If the current control time is the start time of the predetermined time interval, the measurement data acquisition unit 111 acquires the integrated electric energy consumption at a start time of a predetermined time interval. The measurement data acquisition unit 111 can constitute an electric energy consumption acquisition unit.

In step S103, the command value calculation unit 113 calculates the difference between the total electric energy consumption of the group as a whole, integrated during the period from a start time of a predetermined time interval to a current control time, and the total electric power consumption target value, as the target electric energy of the group as a whole integrated during the same period. The command value calculation unit 113 can constitute a target electric energy acquisition unit.

The total electric power consumption target value is electric energy (watt hours, Wh) obtained by integrating a predetermined target electric power (watts, W) for a group as a whole from a start time of a predetermined time interval to a current control time. The total electric power consumption target value may be a value obtained by dividing the total electric energy consumption target value predetermined for one period of the predetermined time interval by the control interval ts, and converting it into an average electric power per control interval ts.

The command value calculation unit 113 can calculate the total electric power consumption target value from the difference between a current integrated energy consumption acquired by the measurement data acquisition unit 111 in step S101 at the same control time, and the integrated electric energy consumption acquired in step S101 at the start time of the predetermined time interval.

If the control time is t and the start time of the predetermined time interval is t0, the command value calculation unit 113 calculates an electric energy difference obtained by subtracting the total electric power consumption target value, integrated during the same period, from the total electric energy consumption of the group as a whole integrated during the period from the start time t0 to the current control time t. The command value calculation unit 113 calculates the difference ΔE (t) as the electric energy difference by Formula (2).

$$Δ E ( t ) = Ptarget \times ( t - t 0 ) - ( E ( t ) - E ( t 0 ) ) \qquad Formula ( 2 )$$

Here, Ptarget is a total electric power consumption target value, E (t) is integrated electric energy consumption at the control time t, and E (t0) is integrated electric energy consumption at the start time t0 of a predetermined time interval, both in units of watt-hours (Wh). Since t=t0 when the control time t is the start time t0 of a predetermined time interval, the difference ΔE (t) determined by Formula (2) is ΔE(t)=0.

In step S105, the command value calculation unit 113 calculates and determines the command value to request charging or discharging by the charge and discharge control device 120 of the electric vehicles EV1 and EV2 in FIG. 1, based on an average electric power obtained by dividing the difference ΔE (t) calculated in step S103 by the control cycle ts. The command value calculation unit 113 determines a command value Pev(t) at the control time t by Formula (3). The command value calculation unit 113 can constitute a command value determination unit.

$$Pev ( t ) = ( Δ E ( t ) \div ts ) \times GAIN \qquad Formula ( 3 )$$

Note that GAIN is the system sensitivity of the electric power system 10 that supplies electric power to the group. The system sensitivity is a parameter that defines the responsiveness of the electric vehicles EV1 and EV2 to the Pev (t) indicated value. The system sensitivity can be, for example, the reciprocal (1/N) of the number N of the electric vehicles EV1 and EV2 present in the group. If the control time t is the start time t0 of a predetermined time interval, the difference ΔE (t)=0. Therefore, the command value Pev (t) determined by Formula (3) is Pev (t)=0.

The average electric energy obtained by dividing the difference ΔE (t) calculated in step S103 by the control cycle ts is the electric energy allocated to all the electric vehicles EV1 and EV2 present in the group during the control cycle ts. By multiplying this by the system sensitivity GAIN, the command value Pev (t) can be a value representing electric energy allocated to each electric vehicle EV1 and EV2 present in the group.

In Formula (3), the average electric energy obtained by dividing the difference ΔE (t), which is calculated in step S103 by the control cycle ts, is multiplied by the system sensitivity GAIN. However, the average electric energy can be multiplied by any other factor than the system sensitivity GAIN.

Since t=t0 when the control time t is the start time t0 of a predetermined time interval, the command value Pev(t) determined by Formula (3) is Pev(t)=0. When the difference ΔE in Formula (3) is greater than or equal to 0, the command value Pev(t) determined by Formula (3) is greater than or equal to 0. The command value Pev(t) greater than or equal to 0 is a command value to request charging of the electric vehicles EV1 and EV2. When the difference ΔE in Formula (3) is less than 0, the command value Pev(t) determined by Formula (3) is less than 0. The command value Pev(t) less than 0 is a command value to request discharging of the electric vehicles EV1 and EV2.

Every time the control time t advances by the control cycle ts from the start time t0 of a predetermined time interval, the difference ΔE(t) determined by the command value calculation unit 113 changes by the integral of the difference ΔE(t) generated while the control time t advances by the control cycle ts.

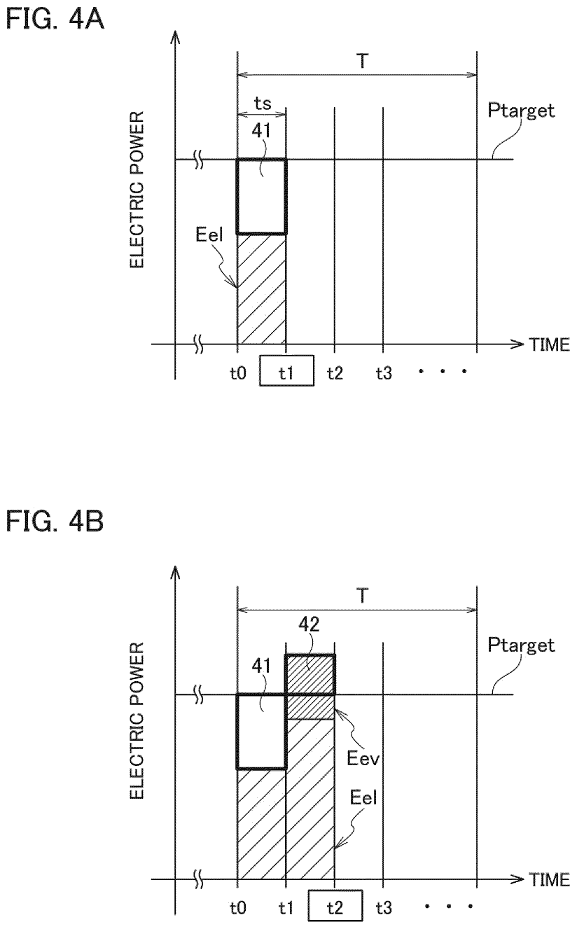

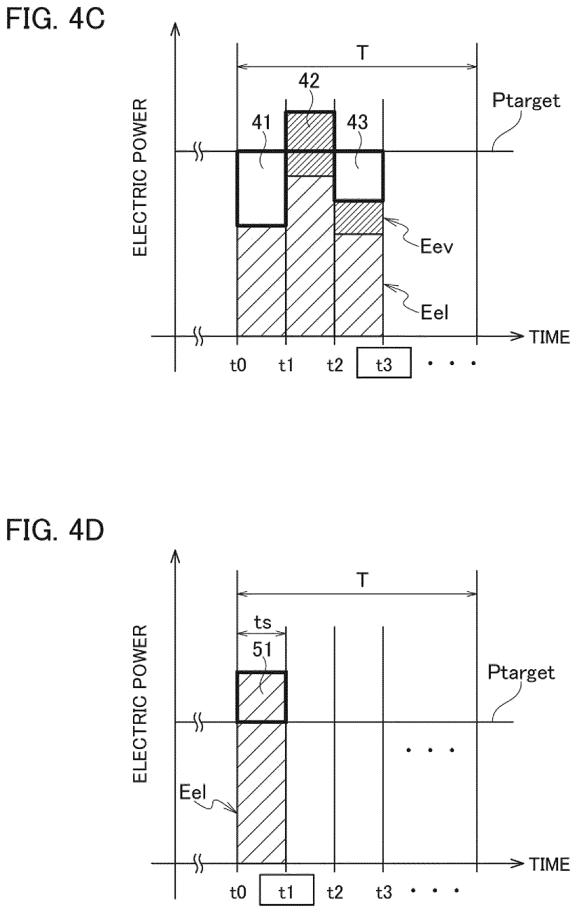

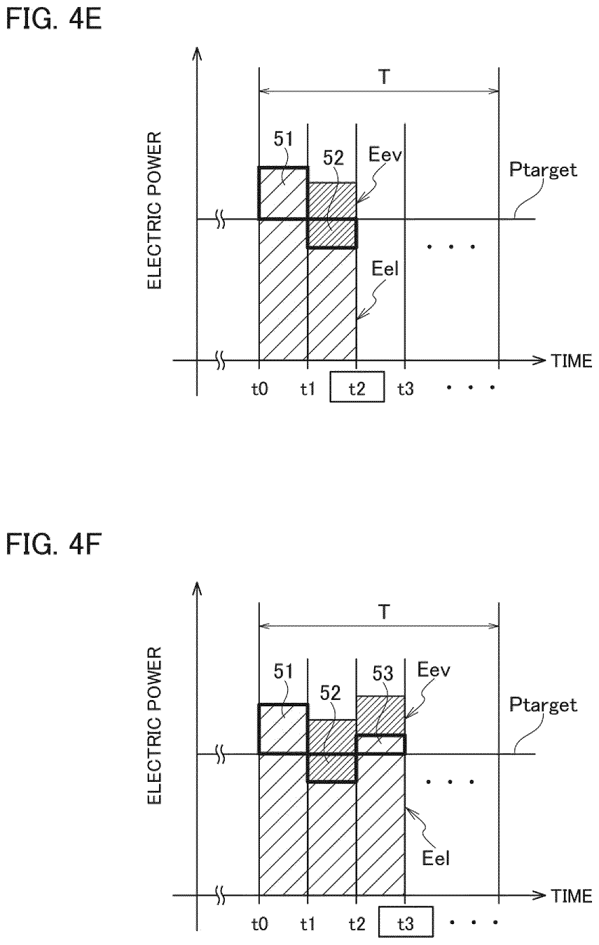

FIGS. 4A to 4C are graphs illustrating a case in which the difference ΔE(t) determined by the command value calculation unit 113 for each control cycle ts during a predetermined time interval changes in a range of values greater than or equal to 0. FIGS. 4D to 4F are graphs illustrating a case in which the difference ΔE(t) determined by the command value calculation unit 113 for each control cycle ts during the predetermined time interval changes in a range of values less than 0.

FIG. 4A illustrates the difference ΔE(t1) of a period from the start time t0 to the control time t1 determined by the command value calculation unit 113 when only one or two electric loads EL1 and EL2 are present in a group at the start time t0 of a predetermined time interval T.

FIG. 4A illustrates a case in which electric energy consumption Eel of the electric loads EL1 and EL2, which is the total electric energy consumption of the group as a whole integrated during the period from the start time t0 to the control time t1, is less than the total electric power consumption target value Ptarget of the group as a whole integrated during the same period. In this case, in the period from the start time t0 to the control time t1, electric power for the electric energy (Wh) corresponding to an area with reference sign 41 remains unconsumed.

At the control time t1 after the control cycle ts from the start time t0, the command value calculation unit 113 determines the remaining power in the area 41 as the difference ΔE(t1) greater than or equal to 0. Using the difference ΔE (t1) at the control time t1, the command value calculation unit 113 determines a command value Pev(t1) greater than or equal to 0, for requesting charging of the electric vehicles EV1 and EV2 in the group, according to Formula (3).

One or two electric vehicles EV1 and EV2 in the group can consume electric power by the electric energy of the difference ΔE(t1) during the period from the control time t1 to t2 by charging based on the command value Pev(t1).

FIG. 4B illustrates a difference ΔE(t2) between the control times t1 and t2 determined by the command value calculation unit 113 at the next control time t2 when charging of one or two electric vehicles EV1 and EV2 added to the group starts at the control time t1, based on the command value Pev(t1).

FIG. 4B illustrates a case in which a sum of the electric energy consumption Eel of the electric loads EL1 and EL2 and the electric power consumption Eev of the electric vehicles EV1 and EV2, which is a total electric energy consumption of the group as a whole integrated during the period from the control time t1 to t2, exceeds the total electric power consumption target value Ptarget during the same period. In this case, electric power for the electric energy (Wh) corresponding to an area with reference sign 42 exceeding the total electric power consumption target value Ptarget is excessively consumed during the period from the control time t1 to t2. The electric energy of the area 42 is less than the electric energy of the area 41.

The command value calculation unit 113 determines electric power obtained by subtracting the electric energy of the area 42 from the electric energy of the area 41 as a difference ΔE(t2) greater than or equal to 0 at the control time t2. Using the difference ΔE(t2) at the control time t2, the command value calculation unit 113 calculates a command value Pev(t2) greater than or equal to 0 for requesting charging of the electric vehicles EV1 and EV2 in the group, according to Formula (3).

One or two electric vehicles EV1 and EV2 in the group can consume electric power by the electric energy of the difference ΔE(t2) during the period from the control time t1 to t2 by charging based on the command value Pev(t2). FIG. 4C illustrates a difference ΔE(t3) during a period from the control time t2 to t3 determined by the command value calculation unit 113 at the next control time t3, when the electric vehicles EV1 and EV2 in the group are charged from the control time t2, based on the command value Pev(t2).

FIG. 4C illustrates a case in which the sum of the electric energy consumption Eel of the electric loads EL1 and EL2, and the electric power consumption Eev of the electric vehicles EV1 and EV2, integrated during the period from the control time t2 to t3 is less than the total electric power consumption target value Ptarget during the same period. In this case, electric power for the electric energy (Wh) corresponding to an area with reference sign 43 remains unconsumed during the period from the control time t2 and t3.

At the control time t3, the command value calculation unit 113 determines the electric power obtained by subtracting the electric energy in the area 42 from the electric energy in the area 41 plus the electric power remaining in the area 43, as the difference ΔE(t3) greater than or equal to 0. Using the difference ΔE(t3) at the control time t3, the command value calculation unit 113 determines a command value Pev(t3) greater than or equal to 0 for requesting charging of the electric vehicles EV1 and EV2 in the group, according to Formula (3).

One or two electric vehicles EV1 and EV2 in the group can consume electric power by the electric energy of the difference ΔE(t3) during the period from the control time t2 and t3 by charging based on the command value Pev(t3).

FIG. 4D illustrates the difference ΔE(t1) of the period from the start time t0 to the control time t1 determined by the command value calculation unit 113 when only one or two electric loads EL1 and EL2 are present in the group at the start time t0 of the predetermined time interval T.

FIG. 4D illustrates a case in which the electric energy consumption Eel of the electric loads EL1 and EL2, which is the total electric power consumption of the group as a whole integrated during the period from the start time t0 to the control time t1, exceeds the total electric power consumption target value Ptarget during the same period. In this case, in the period from the start time t0 to the control time t1, electric power for the electric energy (Wh) corresponding to the area of symbol 51 exceeding the total electric power consumption target value Ptarget is consumed excessively.

At the control time t1 after the control cycle ts from the start time t0, the command value calculation unit 113 determines the electric power excessively consumed in the area 51 as the difference ΔE(t1) less than 0. Using the difference ΔE(t1) at the control time t1, the command value calculation unit 113 determines the command value Pev(t1) less than 0 for requesting discharging of the electric vehicles EV1 and EV2 in the group, according to Formula (3).

One or two electric vehicles EV1 and EV2 in the group can supply electric power by the electric energy of the difference ΔE(t1) to the electric power system 10 during the period from the control time t1 to t2 by performing discharging based on the command value Pev(t1).

FIG. 4E illustrates the difference ΔE(t2) between the control times t1 and t2 determined by the command value calculation unit 113 at the next control time t2 when one or two electric vehicles EV1 and EV2 added to the group start discharging at the control time t1 based on the command value Pev(t1).

FIG. 4E illustrates a case in which the total electric power consumption of the group as a whole, obtained by subtracting the discharge power Eev of the electric vehicles EV1 and EV2 from the electric energy consumption Eel of the electric loads EL1 and EL2 integrated during the period from the control time t1 and t2, is less than the total electric power consumption target value Ptarget during the same period. In this case, electric power for the electric energy (Wh) corresponding to an area with reference sign 52 remains unconsumed during the period from the control time from t1 and t2. The electric energy of the area 52 is less than the electric energy of the area 51.

The command value calculation unit 113 determines the electric power obtained by subtracting the electric energy of the area 52 from the electric energy of the area 51 as a difference ΔE(t2) less than 0 at the control time t2. Using the difference ΔE(t2) at the control time t2, the command value calculation unit 113 determines the command value Pev(t2) less than 0 for requesting discharging of the electric vehicles EV1 and EV2 in the group, according to Formula (3).

One or two electric vehicles EV1 and EV2 in the group can supply electric power by the electric energy of the difference ΔE (t2) to the electric power system 10 during the period from the control time period t1 to t2 by performing discharging based on the command value Pev (t2).

FIG. 4F illustrates the difference ΔE(t3) during the period from the control time t2 to t3 determined by the command value calculation unit 113 at the next control time t3 when the electric vehicles EV1 and EV2 in the group perform discharging from the control time period t2 based on the command value Pev(t2).

FIG. 4F illustrates a case in which the total electric power consumption of the group as a whole, obtained by subtracting the discharge power Eev of the electric vehicles EV1 and EV2 from the electric energy consumption Eel of the electric loads EL1 and EL2 integrated during the period from the control time period t2 to t3, exceeds the total electric power consumption target value Ptarget during the same period. In this case, during the period from the control time t2 to t3, electric power for the electric energy (Wh) corresponding to an area with reference sign 53 exceeding the total electric power consumption target value Ptarget is excessively consumed.

At the control time t3, the command value calculation unit 113 determines the electric power obtained by subtracting the electric energy of the area 52 from the electric energy of the area 51 plus the electric energy of the power area 53 as the difference ΔE (t3) less than 0. Using the difference ΔE(t3) at the control time t3, the command value calculation unit 113 determines the command value Pev(t3) less than 0 for requesting discharging of the electric vehicles EV1 and EV2 in the group, according to Formula (3).

One or two electric vehicles EV1 and EV2 in the group can supply electric power by the electric energy of the difference ΔE(t3) to the electric power system 10 during the period from the control time t2 to t3 by performing discharging based on the command value Pev(t3).

In step S107 of FIG. 3, the command value transmission unit 115 broadcasts the command value Pev(t) determined by operation of the command value calculation unit 113 to the charge and discharge control unit 120 of the electric vehicles EV1 and EV2 via a broadcast unit (not illustrated). As a method of broadcasting, a wireless LAN (Local Area Network) such as Wi-Fi (registered trademark) or Bluetooth (registered trademark) can be used, for example. The command value transmission unit 115 can constitute a broadcast unit.

In step S109, the microcontroller of the command device 110 checks whether a predetermined time interval has elapsed. If the predetermined time interval has not elapsed (NO in step S109), processing returns to step S101, and if the predetermined time interval has elapsed (YES in step S109), a sequence of the processing ends.

### (Electric Vehicle)

Referring to FIG. 1, the configuration of the charge and discharge control device 120 and peripheral devices thereof mounted on each of the electric vehicles EV1 and EV2 connected to the electric wire 12 will be described. Hereinafter, the electric vehicle EV1 among the electric vehicles EV1 and EV2 will be described as an example, but the electric vehicle EV2 has the similar configuration and can operate in the similar manner.

The electric vehicles EV1 and EV2 autonomously control their own charge and discharge power based on the command value Pev(t) broadcast by the command device 110. The electric vehicle EV1 has a charge and discharge device 30, a motor 31, and a battery 33 mounted as peripheral devices to the charge and discharge control device 120. The electric vehicle EV1 has priority β, which indicates the degree to which the charge and discharge of the electric vehicle EV1 has priority over the charge and discharge of the electric vehicle EV2, based on a numerical value (the state of the electric vehicle EV1) representing the user's request for the electric vehicle EV1.

The priority R is also set for the electric vehicle EV2. The priority R of the electric vehicle EV2 is a numerical value indicating the degree to which the charge and discharge of the electric vehicle EV2 has priority over the charge and discharge of the electric vehicle EV1.

The priority R can be a value greater than or equal to 0, and less than or equal to 1, for example, with a minimum value of 0 and a maximum value of 1. When the state of charge (SOC) of the battery 33 is low, a large amount of charge is required, and the priority R is close to 1. Conversely, when the state of charge (SOC) of the battery 33 is high, the priority β is close to 0.

The charge and discharge device 30 is an on-board charger (OBC), and executes charging and discharging of the battery 33 via the electric wire 12 under the control of the charge and discharge control device 120. The charge and discharge device 30 stores received electric power in the battery 33. Alternatively, the charge and discharge device 30 need not store the received electric power in the battery 33, but may directly transmit to the motor 31 as a driving source. The charge and discharge device 30 discharges the electric power stored in the battery 33 or the electric power generated by the electric motor 31 to the electric power grid 11 via the electric wire 12.

The battery 33 includes a secondary battery, a storage battery, and a rechargeable battery for storing the electric power received by the charging and discharging device 30. The motor 31 is a driving source for the electric vehicles EV1 and EV2, driven based on electric energy or electric power stored by the battery 33.

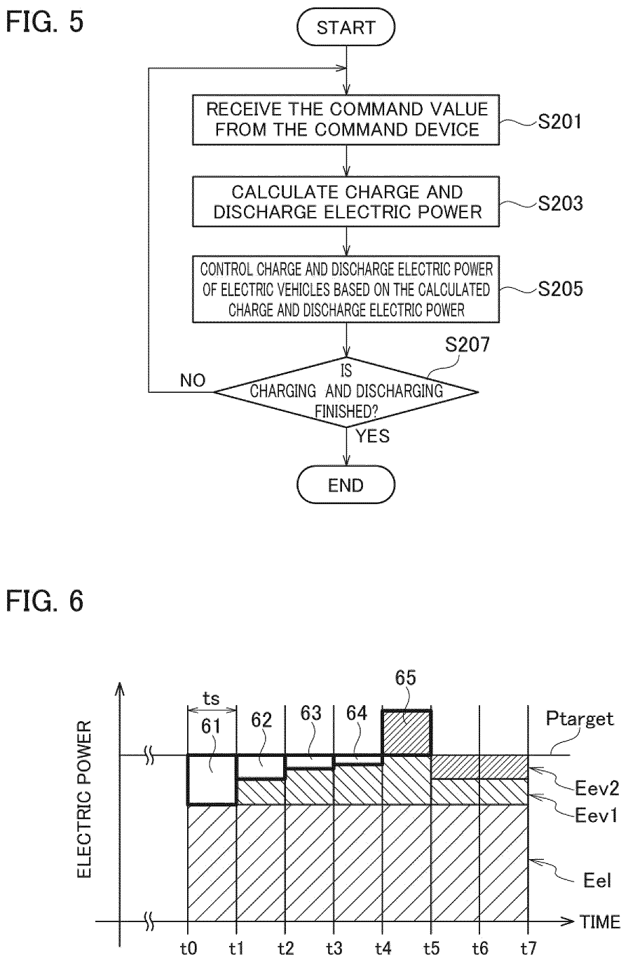

The microcontroller of the charging and discharging control device 120 can configure a command value reception unit 121, a charge and discharge power calculation unit 123, and a charge and discharge electric power control unit 125 with a plurality of information processing circuits that are constructed virtually. The microcontroller executes processing of autonomously controlling charge and discharge electric power of the battery 33 mounted on the electric vehicle EV1 in each control cycle during which a control time arrives. The processing performed by the microcontroller at each control time can be, for example, that illustrated in the flowchart of FIG. 5.

When the microcontroller starts the control, in step S201, the command value reception unit 121 receives the command value Pev(t) broadcast by the command value transmission unit 115 of the command device 110 through a receiver (not illustrated).

In step S203, the charge and discharge electric power calculation unit 123 calculates a charge and discharge electric power value Pchg(t) of the battery 33 mounted on the electric vehicle EV1 based on the command value Pev(t) received by the command value reception unit 121.

The charge and discharge electric power calculation unit 123 calculates a charge and discharge electric power value Pchg_i(t) of an i-th electric vehicle EVi at the control time t using Formula (4) when Pev(t)≥0, and using Formula (5) when Pev(t)<0. When the charge and discharge electric power value Pchg_i(t) is greater than or equal to 0, it becomes a charge electric power value, and when less than 0, it becomes a discharge electric power value.

$$Pchg\_i ( t ) = β i ( t ) \times P e v ( t ) \qquad Formula ( 4 )$$

$$Pchg\_i ( t ) = ( 2 - βi ( t ) ) \times P e v ( t ) \qquad Formula ( 5 )$$

In the above, β(i) is a priority of the i-th electric vehicle EVi at the control time t (0≤βi(t)≤1).

In Formula (5), an absolute value of a value multiplied by the command value Pev(t) is (2−βi(t)) due to the reason described below.

When the command value Pev(t) is for instructing discharge of a value less than 0, the total electric energy consumption of the electric power system 10 is too large even for the electric vehicles EV1 and EV2 with low SOC, and the electric vehicles EV1 and EV2 should be discharged. When the electric vehicles EV1 and EV2 are discharged by the command value Pev(t), all the electric vehicles EV1 and EV2 in the group, even the electric vehicles EV1 and EV2 with the priority close to 1, can be discharged by setting the priority to (2−βi(t)>0).

In step S205, the charge and discharge electric power control unit 125 controls the charge and discharge operation of the batteries 33 by the charge and discharge device 30 of the electric vehicles EV1 and EV2 so that the battery 33 performs charging and discharging by the charge and discharge electric power value Pchg_i(t).

### (Power System Operation)

When the electric vehicles EV1 and EV2 in the group perform charging and discharging based on the command value Pev(t) determined by the command value calculation unit 113 for each control cycle ts, a transition of the total electric power consumption in the group occurs, for example, as illustrated in the graph of FIG. 6. FIG. 6 illustrates a transition of a total electric power consumption of the group as a whole when two electric vehicles EV1 and EV2 are added successively to the group in which only the electric loads EL1 and EL2 are present at the control time t0. Priorities β1 and β2 of the two electric vehicles EV1 and EV2 are assumed to be the same.

In the example of FIG. 6, charging and discharging of a first electric vehicle added to the group first starts at the control time t1, and charging and discharging of the second electric vehicle added to the group thereafter starts at the control time t4.

At the start time t0 of the predetermined time interval T, one or two electric loads EL1 and EL2 in the group consume electric power less than the total electric power consumption target value Ptarget. Until the control time t1 when charging and discharging of the first electric vehicle added to the group starts, the electric energy consumption Eel less than the total electric power consumption target value Ptarget is consumed by the electric loads EL1 and EL2 in the group.

At the control time t1, charging and discharging of the first electric vehicle EV1 added to the group starts. At the control time t1, the command value calculation unit 113 determines the command value Pev(t1) greater than or equal to 0 for requesting charging by using electric energy in an area 61 remaining unconsumed between the start time t0 and the control time t1 as a difference ΔE(t1). The first electric vehicle EV1 perform charging within a range of the command value Pev(t1) between the control times t1 and t2.

At the control time t2, the command value calculation unit 113 determines the command value Pev(t2) of greater than or equal to 0 for requesting charging by using the electric energy obtained by summing up the electric energy in the areas 61 and 62 remaining between the start time t0 and the control time t2 as the difference ΔE(t2). The first electric vehicle EV1 charges within the range of the command value Pev(t2) between control times t2 and t3.

At the control time t3, the command value calculation unit 113 determines the command value Pev(t3) greater than or equal to 0 for requesting charging by using the electric energy obtained by summing up the electric energy in the areas 61 to 63 remaining between the start time t0 and the control time t3 as the difference ΔE(t3). The first electric vehicle EV1 perform charging within a range of the command value Pev(t3) between the control times t3 and t4.

At the control time t4, charging and discharging of the second electric vehicle EV1 added to the group is started. At the control time t4, the command value calculation unit 113 determines a command value Pev (t4) greater than or equal to 0 for requesting charging by using total electric energy in the areas 61 to 64 remaining between the start time t0 and the control time t4 as a difference ΔE(t4). The two electric vehicles EV1 and EV2 perform charging within a range of the command value Pev(t4) between control times t4 and t5.

Between the control times t4 and t5, electric power obtained by summing up the electric power consumption Eel0 of one or two electric loads EL1 and EL2 in the group, and the electric power consumption Eev1 of the first electric vehicle, reaches the total electric power consumption target value Ptarget during the same period. The second electric vehicle EV2 can perform charging between control times t4 and t5 by consuming the electric power of the difference ΔE(t4), which is the total electric power of the areas 61 to 64 remaining between start time t0 and control time t4.

At control time t5, the difference ΔE(t5) is electric energy obtained by subtracting the electric energy of the area 65 consumed by the second electric vehicle EV2 between control times t4 and t5 from electric energy obtained by summing up the electric energy of the areas 61 to 64 remaining between start time t0 and control time t4. The command value calculation unit 113 uses the difference ΔE(t5) to determine a command value Pev(t5) that is greater than or equal to 0 for requesting charging. The two electric vehicles EV1 and EV2 perform charging within a range of the command value Pev(t5) between control times t5 and t6.

FIG. 6 illustrates a state in which electric power, obtained by summing up the electric power consumption Eel0 of the electric loads EL1 and EL2, and the electric power consumption Eev1 and Eev2 of the electric vehicles EV1 and EV2 in the group between control times t5 and t6, is equal to the total electric power consumption target value Ptarget during the same period.

After the control time t6, the same operation as until the control time t5 is performed until the predetermined time interval T elapses.

In the present embodiment, the difference ΔE(t) between the total electric power consumption integrated from the start time t0 of the predetermined time interval T to the control time t, and the total electric power consumption target value, is reflected in the command value Pev(t) at the subsequent control time t. Therefore, even if the electric power consumption Eel0 of the electric loads EL1 and EL2 in the group and the electric power consumption Eev1 of the electric vehicle EV1 reach the total electric power consumption target value Ptarget, the second electric vehicle EV2 can charge the electric power according to the priority β2 immediately after being added to the group.

### Modification of the First Embodiment

In the first embodiment, the charge and discharge electric power value Pchg_i(t) calculated by the electric vehicles EV1 and EV2, based on the command value Pev (t), is a value whose slope is the priority β. In the charge and discharge electric power value Pchg_i(t), the larger the priority β, the larger the amount of charge becomes and the less the discharge amount becomes.

The charge and discharge electric power value Pchg_i(t) calculated by the electric vehicles EV1 and EV2, based on the command value Pev (t), may be a value in which the priority R is the slope and an offset sensitivity α of the charge and discharge characteristics of the electric vehicles EV1 and EV2 is the intercept.

In this case, the charge and discharge electric power calculation unit 123 calculates the charge and discharge electric power value Pchg_i(t) of the i-th electric vehicle EVi at the control time t using Formula (6) when Pev(t)≥0, and Formula (7) when Pev(t)<0. In Formula (6), the value obtained by multiplying the value obtained by subtracting the priority β from 1 by the offset sensitivity α is an absolute value of the intercept.

$$Pchg\_i ( t ) = max \{ 0 , Pe v ( t ) - α i ( t ) \times ( 1 - β i ( t ) ) \} \qquad Formula ( 6 )$$

$$Pchg\_i ( t ) = Pev ( t ) - α i ( t ) \times ( 1 - β i ( t ) ) \qquad Formula ( 7 )$$

However, max{x, y} is a formula for selecting the larger one of x and y, and α(i) is the offset sensitivity of the i-th electric vehicle EVi at the control time t. Offset sensitivity αi (t) can be, for example, αi (t)=1. The larger the value of the offset sensitivity αi(t), the less the amount of charge calculated from the same command value Pev(t) becomes, and the larger the amount of discharge calculated from the same command value Pev t) becomes. Pev(t)−αi(t)×(1−βi(t)) in Formula (6) corresponds to first subtracting the value of the priority βi (t) from 1. The resulting value is multiplied by the offset sensitivity αi (t) of charge and discharge characteristics, then subtracting that result from the command value Pev(t).

### Second Embodiment

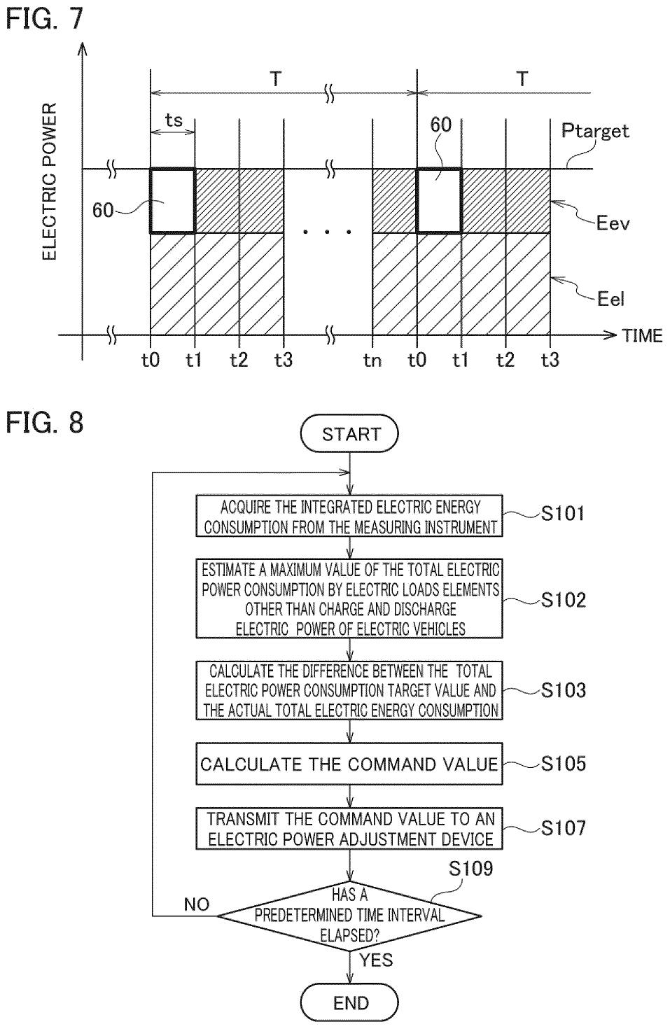

In Embodiment 1 and its modification, when the control time t is the start time t0 of the predetermined time interval, the difference ΔE(t) obtained by Formula (2) becomes ΔE(t)=0, and the command value Pev(t) obtained by Formula (3) becomes Pev(t)=0. Therefore, when the total electric power consumption of the group as a whole is less than the total electric power consumption target value Ptarget in the period from the start time t0 of the predetermined time interval T to the control time t1, for example, the electric energy (Wh) corresponding to the area with reference sign 60 illustrated in FIG. 7 remains unconsumed.

In the charge and discharge control method according to the second embodiment described below, the amount of electric power generated in the region 60 is reduced in the period from the start time t0 to the control time t1, and a charge and discharge opportunity is effectively utilized.

In the charge and discharge control method according to the second embodiment, the microcontroller of the command device 110 illustrated in FIG. 1 executes, for example, the processing illustrated in the flowchart of FIG. 8 at each control time t. The processing illustrated in the flowchart of FIG. 8 is obtained by adding the processing of step S102 between step S101 and step S103 illustrated in the flowchart of FIG. 3. With the addition of step S102, details of the processing of step S105 is slightly changed from those of the first embodiment and its modification.

Details of the processing performed by the microcontroller of the charge and discharge control device 120 illustrated in FIG. 1 at each control time can remain, for example, as illustrated in the flowchart of FIG. 5.

In step S102 of FIG. 8, the command value calculation unit 113 estimates a maximum value Pother_max(t) of the total electric power consumption by the electric loads EL1 and EL2 in the group from the start time t0 of the predetermined time interval T to the control time t using Formula (8) as an estimated maximum value.

$$Pother\_max ( t ) = max \{ Pother\_max ( t - ts ) , ( E ( t ) - E ( t - ts ) ) \div ts - Pev ( t - ts ) \div GAIN \} \qquad Formula ( 8 )$$

Note that max{x, y} is an expression that selects the larger one of x and y. When the control time t is the start time t0 of the predetermined time interval T, the maximum value Pother_max(t) of the total electric power consumption by the electric loads EL1 and EL2 in the group determined by Formula (8) is Pother_max(t)=0. E(t)−E(t−ts))÷ts in Formula (8) corresponds to an average electric energy consumption obtained by dividing the difference between the electric energy consumption acquired during the control cycle ts at this time, and the electric energy consumption acquired during the control cycle ts at a previous time, by the control cycle ts.

Formula (8) is a formula in which the larger value of the first value x and the second value y is set to the maximum value Pother_max(t) of the total electric power consumption by the electric loads EL1 and EL2 in the group by max{x, y}. Here, Pother_max(t−ts) as a first value x is a maximum value of the total electric power consumption by the electric loads EL1 and EL2 in each control cycle ts estimated at each control time t from the start time t0 of the predetermined time interval T to a previous control time t−ts. (E(t)−E(t−ts))÷ts−Pev(t−ts)÷GAIN, which is a second value y, is the total electric power consumption by the electric loads EL1 and EL2 in a period from the previous control time t−ts to the control cycle t at this time.

In step S103 of FIG. 8, the command value calculation unit 113 determines the difference between the total electric power consumption target value Ptarget and the maximum value Pother_max(t) as the difference ΔE(t) instead of the difference ΔE(t) determined by Formula (2).

In step S105, the command value calculation unit 113 calculates and determines the command value Pev(t), based on the maximum value Pother_max(t) estimated in step S102 and the difference ΔE(t) calculated in step S103. The command value calculation unit 113 determines the command value Pev(t) at the control time t by Formula (9).

$$Pev ( t ) = ( Δ E ( t ) \div ts - ( Pother\_max ( t ) - Ptarget ) ) ) \times GAIN \qquad Formula ( 9 )$$

However, the difference ΔE(t)=0 holds when the control time t is the start time t0 of the predetermined time interval, so that the command value Pev (t) determined by Formula (9) is Pev(t)=(Pother_max(t)−Ptarget))×GAIN. As a result, the details of the processing performed in step S105 of FIG. 8 are the same as those of the processing performed in step S105 of FIG. 3. Pother_max(t) in Formula (9) corresponds to the difference between an average target electric energy obtained by dividing the target electric energy by the control cycle ts, and an estimated maximum value of the total electric power consumption by 1 or 2 electric loads EL1 and EL2.

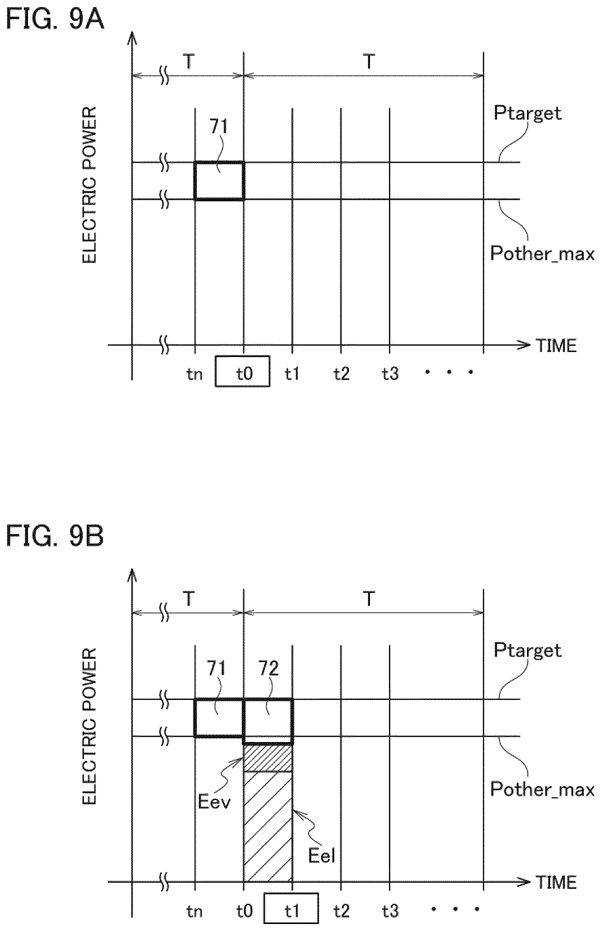

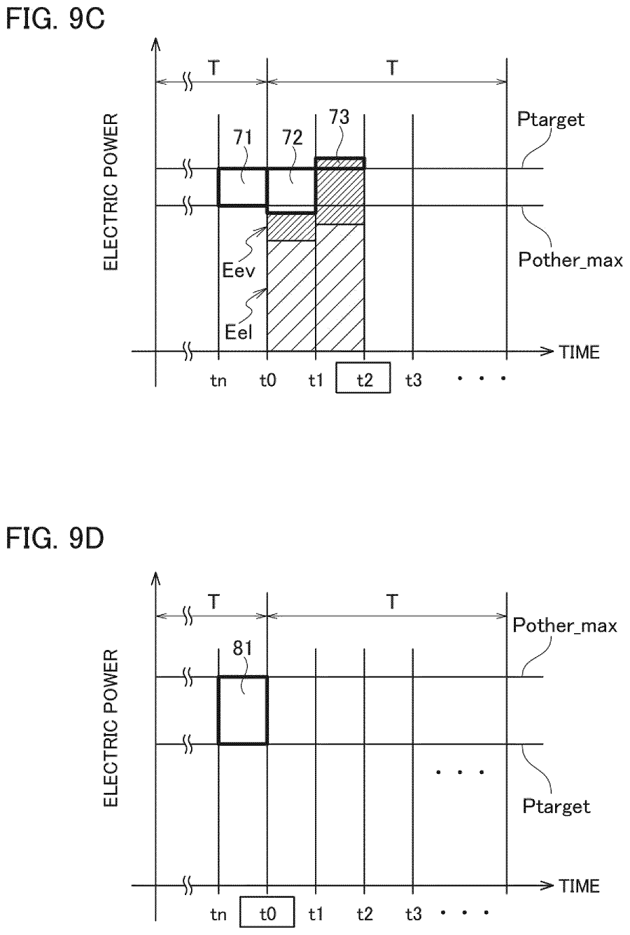

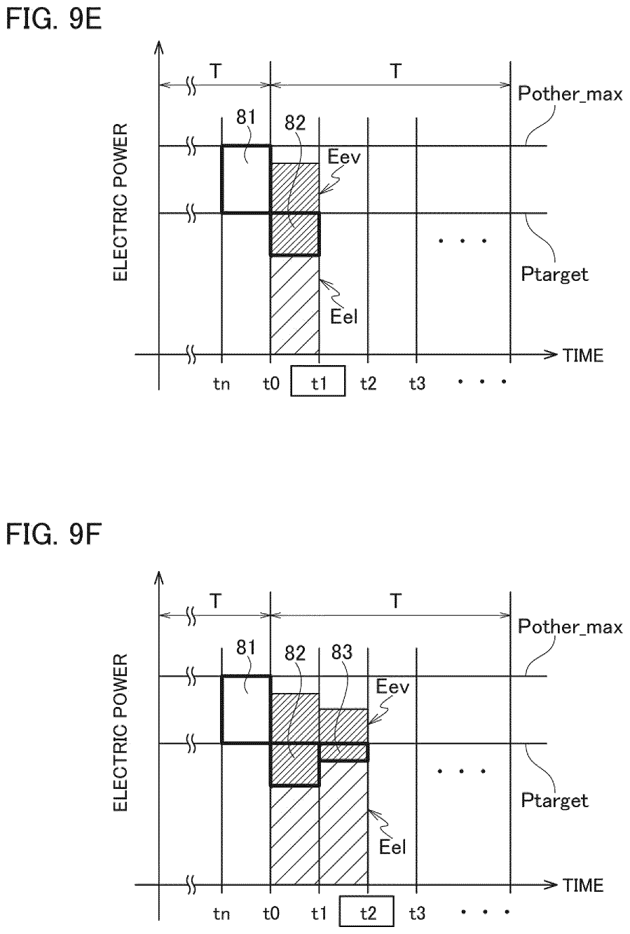

FIGS. 9A to 9C are graphs illustrating a case in which the difference ΔE(t) determined by the command value calculation unit 113 for each control cycle ts during the predetermined time interval T changes in a range greater than or equal to 0 in the charge and discharge control method according to the second embodiment. FIGS. 9D to 9F are graphs illustrating a case where the difference ΔE(t) obtained by the command value calculation unit 113 for each control cycle ts changes in the range of values less than 0.

FIGS. 9A to 9C show a case in which the maximum value Pother_max(t) of the total electric power consumption by the electric loads EL1 and EL2 in the group, which is determined by the command value calculation unit 113, is less than the total electric power consumption target value Ptarget for the group as a whole. The maximum value Pother_max(t) is a value obtained by estimating the maximum value of the total electric power consumption in each control cycle ts by the electric loads EL1 and EL2 in the group at the time interval T immediately before the end at the start time t0.

FIG. 9A illustrates the maximum value Pother_max(t) of the total electric power consumption by the electric loads EL1 and EL2 in the group, which is estimated by the command value calculation unit 113 at the start time t0 of the predetermined time interval T. The maximum value Pother_max(t) is less than the total electric power consumption target value Ptarget. Therefore, the electric energy (Wh) of the difference between the maximum value Pother_max(t) and the total electric power consumption target value Ptarget can be allocated as the electric power consumed by the electric vehicles EV1 and EV2 in the group. The area indicated by reference sign 71 in FIG. 9A represents electric energy that can be allocated to the electric vehicles EV1 and EV2 in the group during the period from the start time t0 to the control time t1.

At the start time t0, the command value calculation unit 113 uses the difference between the total electric power consumption target value Ptarget and the maximum value Pother_max(t) to determine a command value Pev(t0) greater than or equal to 0 for requesting charging of the electric vehicles EV1 and EV2 in the group, according to Formula (9).

By charging the electric vehicles EV1 and EV2 in the group based on the command value Pev(t0), electric power can be consumed in the period from the start time t0 to the control time t1 by the electric energy of the difference between the total electric power consumption target value Ptarget and the maximum value Pother_max(t).

FIG. 9B illustrates the difference ΔE(t1) in the period from the start time t0 to the control time t1 determined by the command value calculation unit 113 at the next control time t1, when charging the electric vehicles EV1 and EV2 in the group starts at the start time t0 based on the command value Pev(t0).

FIG. 9B illustrates a case in which the sum of the electric power consumption Eel of the electric loads EL1 and EL2 and the electric power consumption Eev of the electric vehicles EV1 and EV2, as the total electric power consumption in the group as a whole in the period from the start time t0 to the control time t1, is less than the total electric power consumption target value Ptarget. In this case, in the period from the start time t0 to the control time t1, electric energy (Wh) corresponding to an area indicated by reference sign 72 remains unconsumed.

At the control time t1, the command value calculation unit 113 determines the electric power obtained by summing up the electric energy of the area 71 and the electric energy of the area 72 as the difference ΔE(t1) greater than or equal to 0. Using the difference ΔE(t1) at the control time t1, the command value calculation unit 113 determines the command value Pev(t1) greater than or equal to 0 for requesting charging of the electric vehicles EV1 and EV2 in the group according to Formula (3).

One or two electric vehicles EV1 and EV2 in the group can consume electric power by the electric energy of the difference ΔE (t1) during the period from the control time t1 to t2 by charging based on the command value Pev(t1).

FIG. 9C illustrates the difference ΔE(t2) during the period from the control time t1 to t2 determined by the command value calculation unit 113 at the next control time t2, when electric vehicles EV1 and EV2 in the group perform charging from the control time t1 based on the command value Pev(t1).

FIG. 9C illustrates a case in which the sum of the electric energy consumption Eel of the electric loads EL1 and EL2 and the electric power consumption Eev of the electric vehicles EV1 and EV2 integrated during the period from the control time t1 to t2 exceeds the total electric power consumption target value Ptarget during the same period. In this case, the electric energy (Wh) corresponding to an area with reference sign 73 exceeding the total electric power consumption target value Ptarget is consumed excessively during the period from the control time t1 to t2. The electric energy of the area 73 is less than the electric energy obtained by summing up the electric energy of the areas 71 and 72.

At the control time t2, the command value calculation unit 113 determines the electric power obtained by subtracting the electric energy of the area 73 from the electric energy obtained by summing up the electric energy of the areas 71 and 72 as the difference ΔE(t2) greater than or equal to 0. Using the difference ΔE(t2) at the control time t2, the command value calculation unit 113 determines a command value Pev(t2) greater than or equal to 0 for requesting charging of the electric vehicles EV1 and EV2 in the group according to Formula (3).

One or two electric vehicles EV1 and EV2 in the group can consume electric power by the electric energy of the difference ΔE(t3) during the period from the control time t2 to t3 by charging based on the command value Pev(t2).

FIG. 9D illustrates the maximum value Pother_max(t) estimated by the command value calculation unit 113 at the start time t0 of the predetermined time interval T. The maximum value Pother_max(t) exceeds the total electric power consumption target value Ptarget. Therefore, it can be considered that the electric energy (Wh) corresponding to an area of reference numeral 81, which is the difference between the maximum value Pother_max(t) and the total electric power consumption target value Ptarget, is consumed excessively by the electric loads EL1 and EL2 in the group at the maximum.

At the start time t0, the command value calculation unit 113 determines the electric power considered to be consumed excessively in the area 81 as the difference ΔE(t0) less than 0. Using the difference ΔE(t0) at the start time t0, the command value calculation unit 113 determines the command value Pev(t1) less than 0 for requesting discharging of the electric vehicles EV1 and EV2 in the group, according to Formula (3).

The electric vehicles EV1 and EV2 in the group can supply electric power to the electric power system 10 by the electric energy of the difference ΔE(t0) in the period from the start time t0 to the control time t1 by discharging based on the command value Pev(t0).

FIG. 9E illustrates the difference ΔE(t1) in the period from the start time t0 to the control time t1, determined by the command value calculation unit 113 at the next control time t1 when one or two electric vehicles EV1 and EV2 in the group start discharging at the start time t0 based on the command value Pev(t0).

FIG. 9E illustrates a case in which the total electric power consumption of the group as a whole, obtained by subtracting the discharge electric power Eev of the electric vehicles EV1 and EV2 from the electric energy consumption Eel of the electric loads EL1 and EL2 integrated during the period from the start time t0 to the control time t1, is less than the total electric power consumption target value Ptarget. In this case, the electric energy (Wh) corresponding to an area with reference sign 82 remains unconsumed during the period from the start time t0 to the control time t1. The electric energy of the area 82 is less than the electric energy of the area 81.

At the control time t1, the command value calculation unit 113 determines the electric power obtained by subtracting the electric energy of the area 72 from the electric energy of the area 71 as a difference ΔE(t1) less than 0. Using the difference ΔE(t1) at the control time t1, the command value calculation unit 113 determines the command value Pev(t1) less than 0 for requesting discharge to the electric vehicles EV1 and EV2 in the group, according to Formula (3).

By discharging the electric vehicles EV1 and EV2 in the group based on the command value Pev(t1), the electric power by the electric energy of the difference ΔE(t1) can be supplied to the electric power system 10 during the period from the control time t1 to t2.

FIG. 9F illustrates the difference ΔE(t2) during the period from the control time t1 to t2, determined by the command value calculation unit 113 at the next control time t2, when the electric vehicles EV1 and EV2 in the group perform discharging from the control time t1 based on the command value Pev(t1).

FIG. 9F illustrates a case in which the total electric power consumption of the group as a whole, obtained by subtracting the discharge electric power Eev of the electric vehicles EV1 and EV2 from the electric energy consumption Eel of the electric loads EL1 and EL2 accumulated during the period from the control time t1 to t2, is less than the total electric power consumption target value Ptarget during the same period. In this case, the electric energy (Wh) corresponding to an area with reference sign 83 remains unconsumed during the period from the control time t1 to t2. The electric energy in the area 83 is less than the difference between the electric energy in the area 81 and the electric energy in the area 72.

At the control time t2, the command value calculation unit 113 determines the electric power obtained by subtracting the electric energy obtained by summing up the electric energy of the areas 82 and 83 from the electric energy of the area 81 as the difference ΔE (t2) less than 0. Using the difference ΔE(t2) at the control time t2, the command value calculation unit 113 determines the command value Pev(t2) less than 0, for requesting discharging of the electric vehicles EV1 and EV2 in the group, according to Formula (3).

One or two electric vehicles EV1 and EV2 in the group can supply electric power by the electric energy of the difference ΔE(t3) to the electric power system 10 during the period from the control time t2 to t3 by charging based on the command value Pev(t2).

In the second embodiment, the maximum value Pother_max(t) of the total electric power consumption by the electric loads EL1 and EL2 in the group is estimated during the period from the start time t0 to the control time t1 of the predetermined time interval T. If the estimated maximum value Pother_max(t) is less than the total electric power consumption target value Ptarget, the difference is allocated as the electric power that can be consumed by the electric vehicles EV1 and EV2 during the period from the start time t0 to the control time t1. Therefore, the period from the start time t0 to the control time t1 can be effectively utilized as a charge and discharge opportunity for the electric loads EL1 and EL2.

In the above-described embodiments and modified examples, the calculation of multiplying the command value Pev(t) by the value obtained by subtracting the priority βi(t) in Formula (4), or the priority Pi(t) in Formula (5) from 2, may be omitted. When these calculations are omitted, Formulas (4) and (5) are Pchg_i(t)=Pev(t).

In the above-described embodiments and modifications, the calculation of subtracting the value obtained by multiplying the value, obtained by subtracting the priority βi (t) from 1 by the offset sensitivity αi in Formulas (6) and (7), from the command value Pev (t), may be omitted. When these calculations are omitted, Formula (6) is Pchg_i(t)=max{0, Pev (t)}, and Formula (7) is Pchg_i(t)=Pev (t).

The above-described embodiments are examples of the present invention. Therefore, the present invention is not limited to the above-described embodiments, and it is needless to say that various modifications can be made to the embodiments other than the above-described embodiments in accordance with a design, or the like, as long as they do not deviate from the technical ideas of the present invention.

### Explanation of Signs

10 electric power system
12 electric wire
100 charge and discharge electric power control system
110 command unit
111 measurement data acquisition unit
113 command value calculation unit
115 command value transmission unit
120 charge and discharge control unit
EL1, EL2 electric load
EV1, EV2 electric vehicle
T predetermined time interval
t0 start time
t1 to t6 control time
ts control interval

1. A charge and discharge control method for a charge and discharge element, performed every control cycle from a start time, comprising:
measuring electric energy consumption by integrating electric power consumption of a group including one or more charge and discharge elements, as a whole, from the start time to a control time at which one or more control cycles have elapsed;
acquiring target electric energy by integrating target electric power predetermined for the group as a whole from the start time to the control time; and
determining a command value based on average electric energy, which is obtained by dividing an electric energy difference obtained by subtracting the electric energy consumption from the target electric energy, by the control cycle; and
broadcasting the command value to the one or more charge and discharge elements;
wherein the one or more charge and discharge elements that receive the command value autonomously control their own charge and discharge electric power, based on the command value.

2. The charge and discharge control method according to claim 1, further comprising setting the start time to every hour on the hour, and every hour on the half hour.

3. The charge and discharge control method according to claim 1, further comprising determining the command value, based on a value obtained by multiplying the average electric energy by a system sensitivity of an electric power system supplying electric power to the group.

4. The charge and discharge control method according to claim 3, wherein the system sensitivity is a value obtained by dividing the number of the charge and discharge elements present in the group by 1.

5. The charge and discharge control method according to claim 1,
wherein each of the one or more charge and discharge elements autonomously controls their own charge and discharge electric power to perform charging and discharging at a charge and discharge electric power value determined based on a priority that indicates a degree of priority of their own charging and discharging over the charging and discharging of other charging and discharging elements, and the command value.

6. The charge and discharge control method according to claim 5, wherein:
the priority is a value greater than or equal to 0, and less than or equal to 1, with a minimum value of 0 and a maximum value of 1;
when the command value is greater than or equal to 0, each of the one or more charge and discharge elements have their own charge electric power value, obtained by multiplying the command value by the value of their own priority; and
when the command value is less than 0, an absolute value obtained by multiplying the command value by a value obtained by subtracting the value of their own priority from 2 is their own discharge electric power value.

7. The charge and discharge control method according to claim 5, wherein:
the priority is a value greater than or equal to 0, and less than or equal to 1, with a minimum value of 0 and a maximum value of 1;
when the command value is greater than or equal to 0, each of the one or more charge and discharge elements: calculates a value by subtracting their own priority value from 1; then multiplying by offset sensitivity of their own charge and discharge characteristic; and then subtracting the result from the command value; and compares the calculated value with 0, and uses the larger of the calculated value and 0 as their own charge electric power value; and
when the command value is less than 0, each of the one or more charge and discharge elements calculates an absolute value by subtracting their own priority value from 1; then multiplying by the offset sensitivity; and then subtracting the result from the command value;
and uses as their own discharge electric power value.

8. The charge and discharge control method according to claim 1, wherein:
the group further comprises one or more electric loads that consume electric power;
the charge and discharge control method further comprises:
estimating the maximum value of total electric power consumption due to the one or more electric loads from the start time to the control time; and
determining the command value by multiplying a value, which is obtained by subtracting the difference between average target electric energy obtained by dividing the target electric energy by the control cycle, and an estimated maximum value of the total power consumption due to the one or more electric loads, from the average electric energy, by a system sensitivity of an electric power system supplying electric power to the group.

9. The charge and discharge control method according to claim 8, wherein the estimated maximum value of total electric power consumption due to the one or more electric loads is obtained by subtracting a value, which is obtained by dividing the command value determined in the control cycle at a previous time by the system sensitivity, from average electric energy consumption obtained by dividing the difference between the electric energy consumption acquired in the control cycle at this time, and the electric energy consumption acquired in the control cycle at the previous time, by the control cycle.

10. The charge and discharge control method according to claim 8, wherein the estimated maximum value of the total electric power consumption due to the one or more electric loads is a larger value of: a first value obtained by subtracting a value, which is obtained by dividing the command value determined in the control cycle at the previous time by the system sensitivity, from the average electric energy consumption obtained by dividing the difference between the electric energy consumption acquired in the control cycle at this time, and the electric energy consumption acquired in the control cycle at a previous time, by the control cycle; and a second value which is the estimated maximum value of the total electric power consumption due to the one or more electric loads estimated in the control cycle at the previous time.

11. The charge and discharge control method according claim 8, further comprising estimating at the start time the maximum value of the total electric power consumption due to the one or more electric loads in an immediately preceding predetermined period that ended at the start time, as the maximum value of the total electric power consumption due to the one or more electric loads from the start time to the control time.

12. A charge and discharge control device for a charge and discharge element, performed every control cycle from a start time, comprising:
an electric energy consumption acquisition unit configured to acquire electric energy consumption by integrating electric power consumption of a group including one or more charge and discharge elements, as a whole, from the start time to a control time at which one or more control cycles have elapsed;
a target electric energy acquisition unit configured to acquire target electric energy obtained by integrating target electric power predetermined for the group as a whole from the start time to the control time;
a command value determination unit configured to determine a command value based on average electric energy, which is obtained by dividing an electric energy difference obtained by subtracting the electric energy consumption from the target electric energy, by the control cycle; and
a broadcast unit configured to broadcast the command value to the one or more charge and discharging elements that autonomously control their own charge and discharge electric power based on the command value.
